(19) United States
(12) Patent Application Publication
(10) Pub. No.: US 2013/0087104 A1
(43) Pub. Date: Apr. 11, 2013

(54) Pet toy with interlocking arms and recess for treat

(71) Applicants: Spencer Williams, Bozeman, MT (US); Kathleen Johnson, Bozeman, MT (US); Seth Partain, Bozeman, MT (US); Ron Pierzina, Bozeman, MT (US); Stephen Sanford, Bozeman, MT (US); David Yakos, Bozeman, MT (US); Bryan Walthall, Bozeman, MT (US); Niki Singlaub, Bend, OR (US)

(72) Inventors: Spencer Williams, Bozeman, MT (US); Kathleen Johnson, Bozeman, MT (US); Seth Partain, Bozeman, MT (US); Ron Pierzina, Bozeman, MT (US); Stephen Sanford, Bozeman, MT (US); David Yakos, Bozeman, MT (US); Bryan Walthall, Bozeman, MT (US); Niki Singlaub, Bend, OR (US)

(73) Assignee: Schoggi, Inc. d/b/a West Paw Design, Bozeman, MT (US)

(21) Appl. No.: 13/269,579

(22) Filed: Oct. 8, 2011

(51) Int. Cl. A01K 29/00

(52) U.S. Cl. 119/707

(57) ABSTRACT

A pet toy comprising a head having a recess and two interlocking arms that extend from the head and are situated such that one arm is wrapped around the other to create a barrier to accessing the recess in the head. The head and interlocking arms are comprised of a single durable, flexible and resilient material.

### BACKGROUND OF THE INVENTION

1. Field of the Invention

The present invention relates generally to the field of pet toys, and more specifically, to a pet toy with a recess for a treat and interlocking arms that restrict access to the recess when they are interlocked.

2. Description of the Related Art

Pet toys have been designed with recesses for inserting pet treats. The present invention is an improvement over such pet toys in that it incorporates a structural feature, described more fully below, that requires the pet to “unlock” the toy before accessing the treat. As with prior art toys, the pet still has to figure out a way to remove the treat from the recess; however, prior art toys do not incorporate the additional locking feature of the present invention. In addition, the present invention has been designed so that when the locking feature is engaged, the toy forms a unique shape that causes it to spiral during flight (like a football).

Examples of prior art pet toys include: U.S. Pat. No. 5,947,061 (Markham et al., 1999), which describes a pet toys with one or more receptacles for receiving treats; U.S. Pat. No. 6,439,166 (Markham, 2002), which provides a pet toy with a hollow core for receiving animal treats or a buoyant material that allows the toy to float; and U.S. Pat. No. 6,470,830 (Mann, 2002), which discloses a pet toy whose body is comprised of a resilient material with a cavity or slot for receiving a pet treat or similar “attractant.” U.S. Pat. No. 7,389,748 (Shatoff et al., 2008) and U.S. Pat. No. 7,591,234 (Shatoff et al., 2009) and U.S. Patent Application Pub. No. 2009/0064942 (Shatoff et al.) describe an animal toy with internal chambers that allow the toy to be connected to other toy, thereby creating a larger and more complex toy system. U.S. Pat. Nos. D556,393 (Rutherford et al., 2007) and D585,162 (Partain et al., 2009) cover designs for pet toys with recesses for the insertion of pet treats.

U.S. Patent Application Pub. No. 2008/003270 (Martinez) discloses a chewable and/or edible product for pets and other animals that is comprised of a fibrous collagenous matrix that can be formed into any shape or design. U.S. Patent Application Pub. No. 2009/0025649 (Gamble et al.) shows a pet device that holds chewable objects for pets. The device comprises a base support, a bone or object holding structure, and an optional hold down lid to contain the object. U.S. Patent Application Pub. No. 2009/0255482 (Santarsiero) provides a pet toy comprising two bodies, one of which has an opening for receiving a shaft of the other body.

None of the pet toys discussed above includes interlocking arms that form an enclosure over a recess in the pet toy for receiving treats. In the present invention, the interlocking arms engage the pet by requiring the pet not only to remove the treat from the recess but also to disengage the interlocking arms to access the recess. In addition, none of the pet toys discussed above forms the same shape as the present invention when the arms are interlocked, thereby causing the toy to spiral when thrown and further stimulating the pet during a game of fetch.

### BRIEF SUMMARY OF THE INVENTION

The present invention is a pet toy comprising a head having a recess and two interlocking arms that extend from the head and are situated such that one arm is wrapped around the other to create a barrier to accessing the recess in the head, wherein the head and interlocking arms are comprised of a single durable, flexible and resilient material. In a preferred embodiment, each interlocking arm comprises an elbow area, a wrist area, and a hand area, and the wrist areas of the interlocking arms are wrapped around each other to create the barrier.

In a preferred embodiment, the toy has a central vertical axis, each interlocking arm comprises an elbow-to-wrist-area, the elbow-to-wrist area of each interlocking arm is at an angle to the central vertical axis of the toy, and the elbow-to-wrist areas of each interlocking arm are angled in opposite directions relative to the central vertical axis of the toy. Preferably, the interlocking arms are situated on the head at an angle in the range of seventy-five (75) to forty-five (45) degrees apart from each other. The elbow areas of each interlocking arm preferably do not come into contact with one another when one arm is wrapped around the other, thereby creating a space directly outside of the recess between the recess and the interlocked wrist areas of each arm.

### BRIEF DESCRIPTION OF THE DRAWINGS

FIG. 1 is a first perspective view of the present invention with the interlocking arms in a non-interlocked position.

FIG. 2 is a second perspective view of the present invention with the arms in an interlocked position.

FIG. 3 is a third perspective view of the present invention with the interlocking arms in a non-interlocked position.

FIG. 4 is a fourth perspective view of the present invention with the arms in an interlocked position.

FIG. 5 is a front view of the present invention with the interlocking arms in a non-interlocked position.

FIG. 6 is a side view of the present invention with the interlocking arms in a locked position.

FIG. 7 is a side view of the present invention with the interlocking arms in a non-interlocked position.

### REFERENCE NUMBERS

1 Head

2 First interlocking arm

2a First elbow

2b First wrist

2c First hand

3 Second interlocking arm

3a Second elbow

3b First wrist

3c First hand

4 Recess

4a Space

### DETAILED DESCRIPTION OF INVENTION

FIG. 1 is a first perspective view of the present invention with the interlocking arms in a non-interlocked position. As shown in this figure, the present invention is a pet toy comprised of a single piece of molded material that is durable, flexible and resilient. An ideal material for this purpose is the durable thermoplastic material from which West Paw Design's ZOGOFLEX® pet toys are made.

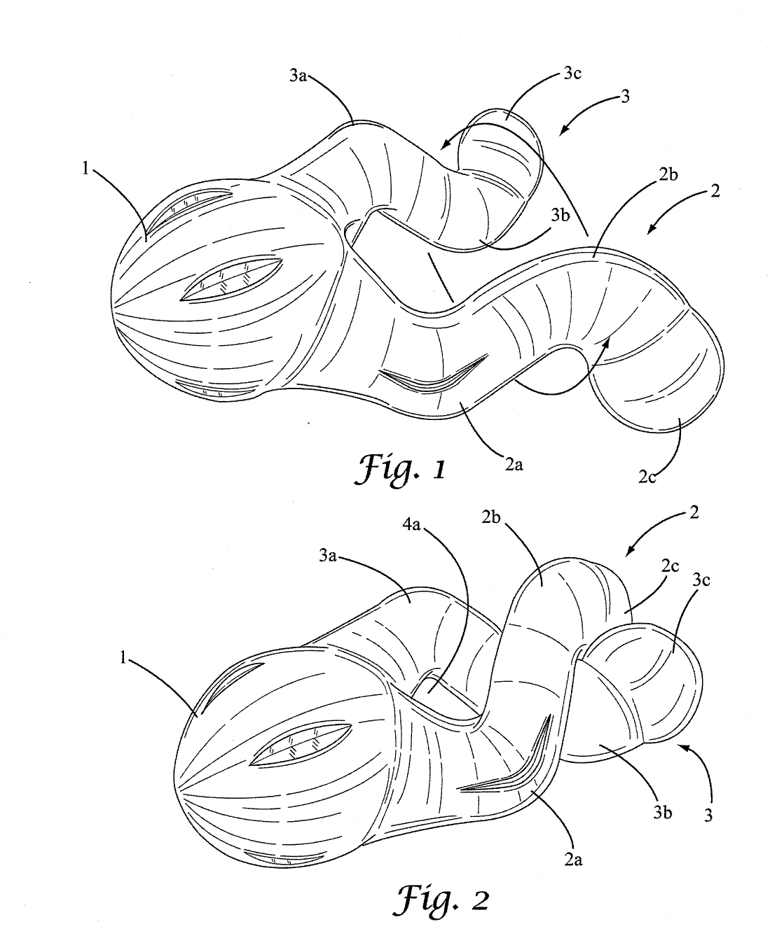

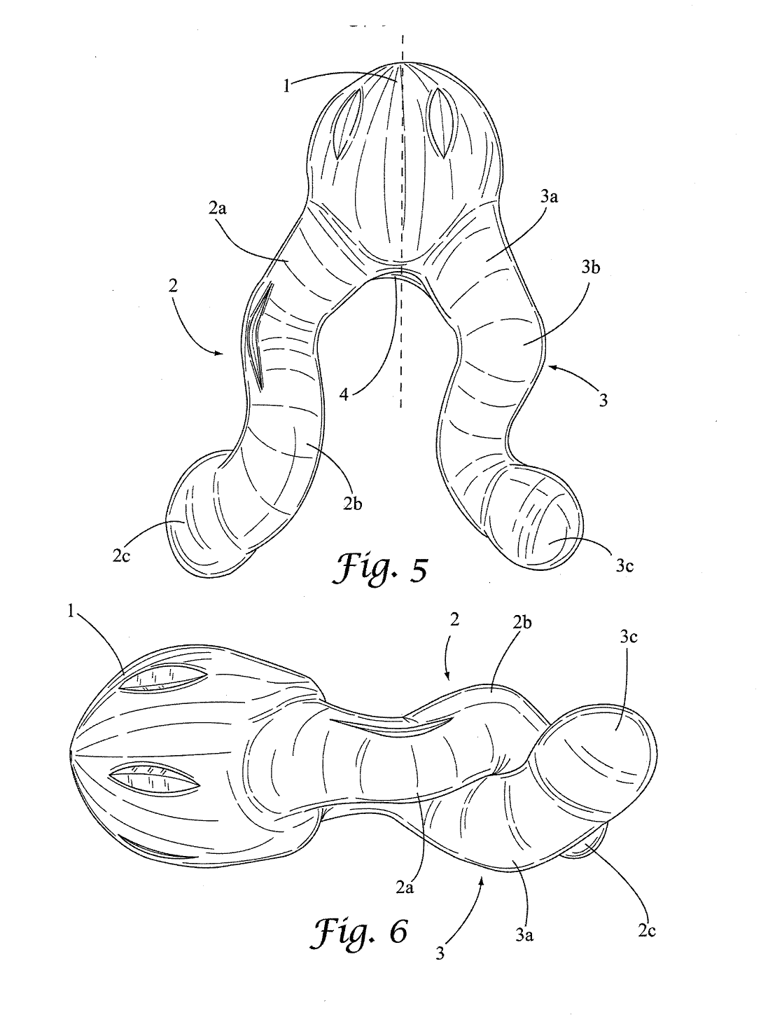

The toy comprises a head 1 and two interlocking arms 2, 3 that extend from the head 1. The interlocking arms 2, 3 are each situated roughly at 5:00 and 7:00 on the head 1 (see FIG. 5), and they are shaped so that one arm 2 may be wrapped around the other 3 to form a closure (or barrier) around the recess 4 (see FIGS. 2 and 4) in the head 1. Although the arms 2, 3 are shown in the figures as approximately sixty (60) degrees apart, the present invention is not limited to this exact spacing. It is contemplated by the inventors that the interlocking arms 2, 3 may be spaced so that they are in the range of seventy-five (75) to forty-five (45) degrees apart.

The purpose of the recess 4 is to allow a pet treat (not shown) to be inserted into the recess 4. To access the treat, the pet has to first figure out how to unlock the interlocking arms 2, 3 and then remove the treat from the recess 4. The toy thus provides mental stimulation to a pet and keeps the pet occupied for a significant period of time. Another advantage of the present invention is that by providing a hollow cavity in the head 1, the toy compresses and rebounds to provide stimulation to a chew-motivated pet.

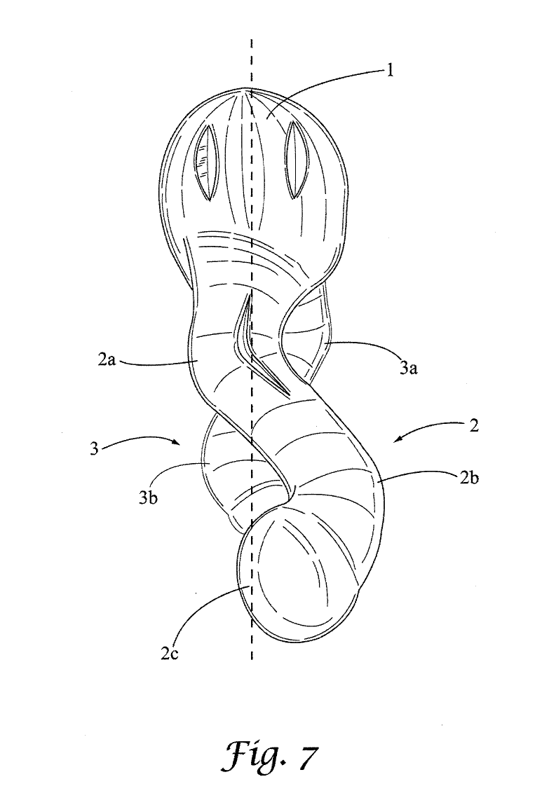

In a preferred embodiment, each interlocking arm 2, 3 comprises an elbow 2a, 3a, a wrist 2b, 3b, and a hand 2c, 3c. To lock the interlocking arms 2, 3 to form a closure around the recess 4 in the head 1, one hand 2c is placed over and around the other hand 3c, and the wrist areas 2b, 2c are wrapped around each other. The arrows shown in FIGS. 1 and 4 suggest that one arm 2 is wrapped around the other arm 3 in a particular direction; however, the arms may also be wrapped around each other in the opposite direction to create a tighter hold (and a more difficult challenge for the pet to unlock the toy). As shown in FIG. 7, the part of the arm 2 that extends from the elbow 2a to the wrist 2b is preferably at an angle opposite that of the other arm 3 to make it easier to wrap the arms around each other in one direction (the direction indicated in FIGS. 1 and 4) and more difficult to wrap the arms around each other in the opposite direction. In a preferred embodiment, the angle between the central vertical axis of the toy (see FIG. 7) and the elbow-to-wrist portion of the arm is approximately forty-five (45) degrees.

The elbow areas 2a, 3a on each interlocking arm 2, 3 extend outward from the central axis of the head 1 (see FIG. 5) and do not come into contact with one another, thereby creating an opening 4a (see FIGS. 2 and 4) directly outside of the recess 4 in the head 1. Leaving an opening (or space) 4a outside of the recess 4 and not completely closing it off allows the pet to view and smell the treat inside the recess 4. The elbows 2a, 3a and the space 4a created by the elbows is also important in creating the football-like shape described below when the interlocking arms 2, 3 are in a locked position.

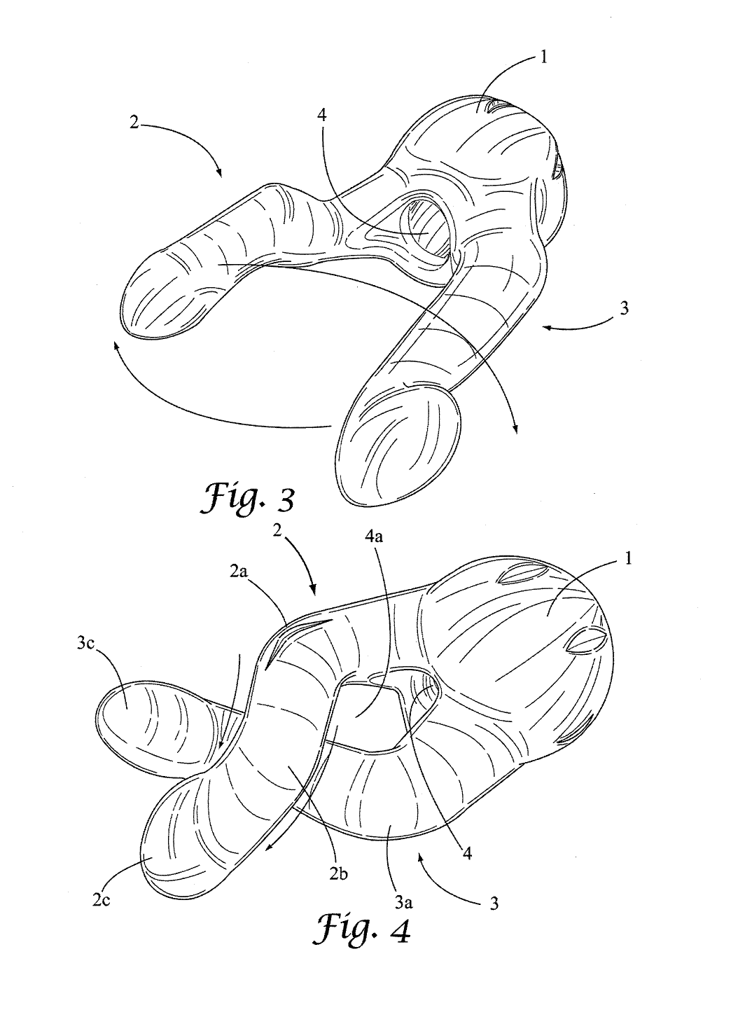

To unlock the interlocking legs 2, 3, simply unwrap the wrist areas 2b, 3b by pushing the two hands 2a, 3a apart. The resilient material from which the toy is made causes the toy to spring back to the shape shown in FIGS. 1 and 3. The fact that the material is flexible allows it to be manipulated to lock and unlock the interlocking arms 2, 3, and it must be durable in order for a pet to play with it (and chew on it).

FIG. 2 is a second perspective view of the present invention with the arms in an interlocked position. This figures shows the wrist areas 2b, 3b wrapped around each other

FIG. 3 is a third perspective view of the present invention with the interlocking arms in a non-interlocked position. This figure shows the recess 4 into which a pet treat may be inserted.

FIG. 4 is a fourth perspective view of the present invention with the arms in an interlocked position. This figure clearly shows the space 4a that is created directly outside of the recess 4. It also shows the hands 2c, 3c and wrist area 2b. Wrist area 3b is hidden from view in this figure. Both elbow areas 2a, 3a are also shown.

In addition to providing a challenge for pets that will keep them occupied for significant periods of time, the present invention provides another unique advantage in that when the arms are interlocked, the shape of the toy resembles a football (see FIG. 6). The toy, therefore, can be thrown long distances in a spiral formation. The spiraling flight characteristics of the toy motivate a dog to chase it by stimulating the dog's prey drive. To maximize flight distance, the toy should be thrown with the interlocking arms 2, 3 in a locked position (as shown in FIGS. 2 and 4). In sum, the present invention functions both as a chew-friendly, treat toy and also as an interactive, fetch toy.

It should be noted that due to the flexibility of the material from which the invention is preferably made, when the toy is thrown into the air and lands on a surface (such as the ground), it will typically bounce and unlock. This bouncing characteristic stimulates a dog and helps the flying toy travel farther after it hits the ground. The action of the arms unlocking resembles a fleeing animal and provides even more stimulation to a chasing dog.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A pet toy comprising:
(a) a head having a recess; and
(b) two interlocking arms that extend from the head and are situated such that one arm is wrapped around the other to create a barrier to accessing the recess in the head;
wherein the head and interlocking arms are comprised of a single durable, flexible and resilient material.

2. The pet toy of claim 1, wherein each interlocking arm comprises an elbow area, a wrist area, and a hand area, and wherein the wrist areas of the interlocking arms are wrapped around each other to create the barrier.

3. The pet toy of claim 2, wherein the toy has a central vertical axis, wherein each interlocking arm comprises an elbow-to-wrist-area, wherein the elbow-to-wrist area of each interlocking arm is at an angle to the central vertical axis of the toy, and wherein the elbow-to-wrist areas of each interlocking arm are angled in opposite directions relative to the central vertical axis of the toy.

4. The pet toy of claim 2, wherein the interlocking arms are situated on the head at an angle in the range of seventy-five (75) to forty-five (45) degrees apart from each other.

5. The pet toy of claim 2, wherein the elbow areas of each interlocking arm do not come into contact with one another when one arm is wrapped around the other, thereby creating a space directly outside of the recess between the recess and the interlocked wrist areas of each arm.
